(19) United States
(12) Patent Application Publication
(10) Pub. No.: US 2007/0237084 A1
(43) Pub. Date: Oct. 11, 2007

(54) Data communication using multiple input/output devices

(76) Inventors: Michael A. Rothman, Puyallup, WA (US); Vincent J. Zimmer, Federal Way, WA (US)

Correspondence Address: SCHWABE, WILLIAMSON & WYATT, P.C., PACWEST CENTER, SUITE 1900, 1211 S.W. FIFTH AVE., PORTLAND, OR, 97204, US

(21) Appl. No.: 11/393,056

(22) Filed: Mar. 29, 2006

(51) Int. Cl. H04L 12/26; G06F 15/173

(52) U.S. Cl. 370/237; 709/239

(57) ABSTRACT

Methods and devices that facilitate transmission and/or reception of data packets in a platform through a first and a second input/output (I/O) device are described herein. The platform may be a partitioned platform that includes a main and a service partition, wherein the first I/O device may be an in-band I/O device associated with a main partition of the platform and the second I/O device is an out-of-band I/O device associated with a service partition of the platform. The data packets to be transmitted may be data packets that originate from the main partition while the data packets to be received may be destined for the main partition.

### TECHNICAL FIELD

Embodiments of the present invention relate to the field of data communication, more specifically, to data communication using multiple input/output devices.

### BACKGROUND

Input/output (I/O) devices such as network interface cards (NICs) are commonly employed by platforms to interface and communicate through one or more networks. As used herein, a “platform” may refer to the general framework of a computing device including various hardware, software, and firmware that typically comprise a computing device. A computing device may be any type of processor based system having various form factors including, for example, personal computers, mobile or desktop, set-top boxes, personal digital assistants (“PDAs”), web tablets, and so forth. A “network” may refer to any type of network including, for example, a local area network (LAN), a wide area network (WAN), a wireless LAN or simply WLAN, and so forth.

Many of today's platforms will typically employ multiple I/O devices, each I/O device being dedicated for particular purposes. For example, many current platforms are being partitioned into at least two portions, a main partition and a service partition. The main partition of a platform will typically include at least the main processor (i.e., central processing unit or simply “CPU”), the operating system (O/S), and one or more I/O devices (herein “in-band I/O devices”). The service partition will typically include at least a management controller and one or more I/O devices (herein “out-of-band I/O devices”). Generally the main partition performs various operations relating to, for example, user applications and the O/S. The service partition, in contrast, generally operates independently from the O/S and the main partition and provides various management functions. These management functions may include, for example, management of the platform when the platform is in a low power state or allowing third parties such as a network administrator or an enterprise information technology (IT) department to access the platform independent of the main partition using, for example, the out-of-band I/O device(s). The out-of-band I/O device(s) is(are) typically dedicated for use only by the service partition and is(are) typically not known or visible to the O/S. Because the out-of-band I/O device(s) is(are) not known to the main partition (e.g., O/S or the user applications), the out-of-band I/O device(s) often remain idle unless it is actually being used by the service partition.

### BRIEF DESCRIPTION OF THE DRAWINGS

Embodiments of the present invention will be readily understood by the following detailed description in conjunction with the accompanying drawings. To facilitate this description, like reference numerals designate like structural elements. Embodiments of the invention are illustrated by way of example and not by way of limitation in the figures of the accompanying drawings.

FIG. 1 illustrates a partitioned platform in accordance with various embodiments of the present invention;

FIG. 2 illustrates a system in accordance with various embodiments;

FIG. 3 illustrates another system in accordance with various embodiments;

FIG. 4 illustrates a process for transmitting data packets using multiple I/O devices in accordance with various embodiments; and

FIG. 5 illustrates a process for receiving data packets using multiple I/O devices in accordance with various embodiments.

### DETAILED DESCRIPTION OF ILLUSTRATIVE EMBODIMENTS OF THE INVENTION

In the following detailed description, reference is made to the accompanying drawings which form a part hereof wherein like numerals designate like parts throughout, and in which is shown by way of illustration embodiments in which the invention may be practiced. It is to be understood that other embodiments may be utilized and structural or logical changes may be made without departing from the scope of the present invention. Therefore, the following detailed description is not to be taken in a limiting sense, and the scope of embodiments in accordance with the present invention is defined by the appended claims and their equivalents.

Various operations may be described as multiple discrete operations in turn, in a manner that may be helpful in understanding embodiments of the present invention; however, the order of description should not be construed to imply that these operations are order dependent.

The description may use perspective-based descriptions such as up/down, back/front, and top/bottom. Such descriptions are merely used to facilitate the discussion and are not intended to restrict the application of embodiments of the present invention.

For the purposes of the present invention, the phrase “A/B” means A or B. For the purposes of the present invention, the phrase “A and/or B” means “(A), (B), or (A and B).” For the purposes of the present invention, the phrase “at least one of A, B and C” means “(A), (B), (C), (A and B), (A and C), (B and C) or (A, B and C).” For the purposes of the present invention, the phrase “(A)B” means “(B) or (AB)” that is, A is an optional element.

The description may use the phrases “in various embodiments,” or “in some embodiments,” which may each refer to one or more of the same or different embodiments. Furthermore, the terms “comprising,” “including,” “having,” and the like, as used with respect to embodiments of the present invention, are synonymous.

Embodiments of the present invention provide methods and devices that facilitate a partitioned platform to transmit and/or receive data packets using at least a first and a second I/O device, wherein the first I/O device may be an in-band I/O device and the second I/O device may be an out-of-band I/O device. The transmission and/or reception rate of data packets by a main partition of the platform (i.e., computing device) may be increased by using both the in-band and the out-of-band I/O devices. For the embodiments, the transmission of data packets by the main partition may be facilitated by intercepting the data packets that are designated for transmission through the first I/O device and re-routing at least a subset of the data packets for transmission through the second I/O device. Alternatively or in the same embodiments, reception of data packets by the partitioned platform may be facilitated by reception of a first and a second set of data packets through the first and the second I/O devices, respectively. Upon reception of the first and the second set of data packets, the second set of data packets may be merged with the first set of data packets before the resulting merged data packets are received by, for example, the main partition.

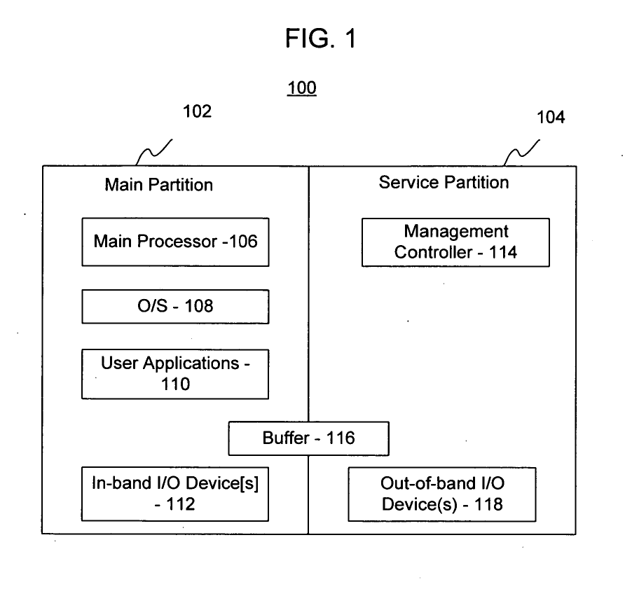

FIG. 1 depicts a partitioned platform in accordance with various embodiments. The platform 100 may be segmented into at least a main partition 102 and a service partition 104. Note that the partitioning may be as a result of hardware partitioning, software partitioning, or a combination of hardware/software partitioning. The main partition 102 may include at least a main processor (i.e., central processing unit or simply “CPU”) 106, operating system (O/S) 108, user applications 110, and in-band I/O device(s) 112. The service partition 104 may include at least management controller 114 and out-of-band I/O device(s) 118. A buffer 116 is shown as being shared by both the main partition 102 and the service partition 104. However, in alternative embodiments, the buffer 116 may reside in either the main partition 102 or the service partition 104. Further, in other alternative embodiments, other components in addition to those depicted may be present in the platform 100. Though not explicitly depicted, in an at least partially software/firmware implementation, the platform 100 may further include a storage medium for storing instructions that enables the management controller 114 to perform various operations as will be described below. Further, in some embodiments, the O/S 108 and/or user applications 110 may be stored in a mass storage device (not shown) coupled with platform 100.

In accordance with various embodiments, reception and/or transmission of data packets to or from the main partition 102 may be via both the in-band I/O device(s) 112 and the out-of-band I/O device(s) 118. In particular, when the main partition 102 is to transmit and/or receive data packets, the management controller 114 may facilitate the transmission and/or reception of at least a subset of such data packets via the out-of-band I/O device(s) 118 even though the O/S 108 and/or user applications 110 may not be aware of the out-of-band I/O device(s) 118. In some embodiments, data packet transmission using the out-of-band I/O device(s) 118 may be particularly useful if the out-of-band I/O device(s) 118 has idle periods in which the out-of-band I/O device(s) 118 is/are not being used by the service partition 104. That is, since the out-of-band I/O device(s) 118 may be dedicated for use only by the service partition 104, which may only use the out-of-band I/O device(s) 118 for platform management operations, the out-of-band I/O device(s) 118 may remain largely idle. Thus, by employing the largely idle out-of-band I/O device(s) 118, the reception and/or transmission rate of data packets to and/or from the main partition 102 may be increased. In some embodiments, the data packets to be transmitted and/or received may be transmission control protocol (TCP) packets that may include fields, such as those in the headers of the data packets, which may indicate the source and destinations of the data packets.

When the main partition 102 is to transmit data packets, the data packets to be transmitted may be designated for transmission through the in-band I/O device(s) 112. The management controller 114 may then detect that the main partition is trying to transmit data packets and may facilitate the interception of the data packets to be transmitted. Depending upon the circumstances, the management controller 114 may then re-route at least a subset of the data packets to the out-of-band device(s) 118 while continuing to allow the rest of the data packets to be routed to the in-band I/O device(s) 112. That is, in various embodiments, the management controller 114 may monitor the in-band and/or the out-of-band I/O devices 112 and 118 to determine their availability for transmitting data packets and based on this determination, route the data packets selectively to the in-band and the out-of-band devices 112 and 118.

In some embodiments, the management controller 114 may facilitate the configuration of those data packets to be re-routed to the out-of-band I/O device(s) 118 to indicate that the re-routed data packets are sourced from the out-of-band I/O device(s) 118. That is, the data packets to be re-routed to the out-of-band I/O device(s) 118 may have been generated with, for example, fields in their headers that indicate that they are sourced from the in-band I/O device(s) 112. Thus, in order to indicate to the destination of the data packets that the data packets were sourced or transmitted through the out-of-band I/O device(s) 118, the headers of the data packets may be altered. In some embodiments, the configuration of these data packets may entail adding a medium access control (MAC) address of the out-of-band I/O device(s) 118 into the data packets replacing the original source address (e.g., address of the in-band I/O device(s) 112). As a result, the destination of the data packets is made “aware” that the data packets transmitted through the out-of-band I/O device(s) 118 is sourced from the out-of-band I/O device(s) 118. Alternatively, the data packets to be re-routed to the out-of-band I/O device(s) 118 may not be configured, in which case the destination of the data packets will “think” that the data packets were sourced from the in-band I/O device(s) 112.

Because the service partition 104 may operate independently from the O/S 108, the re-routing of the data packets for transmission through the out-of-band I/O device(s) 118 may be performed completely independently from the O/S 108.

In various embodiments, the interception of the data packets may be by trapping the data packets in the buffer 116. The trapped data packets may then be bifurcated into a first and a second subsets of data packets to be routed to the in-band and out-of-band I/O devices 112 and 118, respectively.

In accordance with various embodiments, the platform 100 may receive a first and a second set of data packets through the in-band and the out-of-band I/O devices 112 and 118, respectively. For the embodiments, the management controller 114 may facilitate the reception of the second set of data packets through the out-of-band I/O device(s) 118. Upon reception of the second set of data packets through the out-of-band I/O device(s) 118, the second set of data packets may be configured to indicate that the second set of data packets were received through the in-band I/O device(s) 112 instead of the out-of-band I/O device(s) 118 as they actually were. As a result, the platform destination (e.g., main partition 102) that is to receive the second set of data packets may “think” that the second set of data packets are being received through the in-band I/O device(s) 112. The configuration of the second set of data packets, in some embodiments, may be as a result of adding MAC address or addresses of the in-band I/O device(s) 112 into the second set of data packets received through the out-of-band I/O device(s) 118. The addition of the MAC address or addresses of the in-band I/O device(s) 112 may result in the replacement of the MAC address or addresses of the out-of-band I/O device(s) 118 that may have been already included in the second set of data packets when the second set of data packets were initially received through the out-of-band I/O device(s) 118.

After configuring the second set of data packets, the second set of data packets may be merged with the first set of data packets received through the in-band I/O device(s) 112 prior to the merged data packets being received by the platform destination. In some embodiments, the merging of the first and the second sets of data packets may be by interleavingly filling the buffer 116. As the buffer 116 is filled, alerts may be generated and provided to, for example, the main partition 102. The resulting merged data packets may then be received by their platform destination.

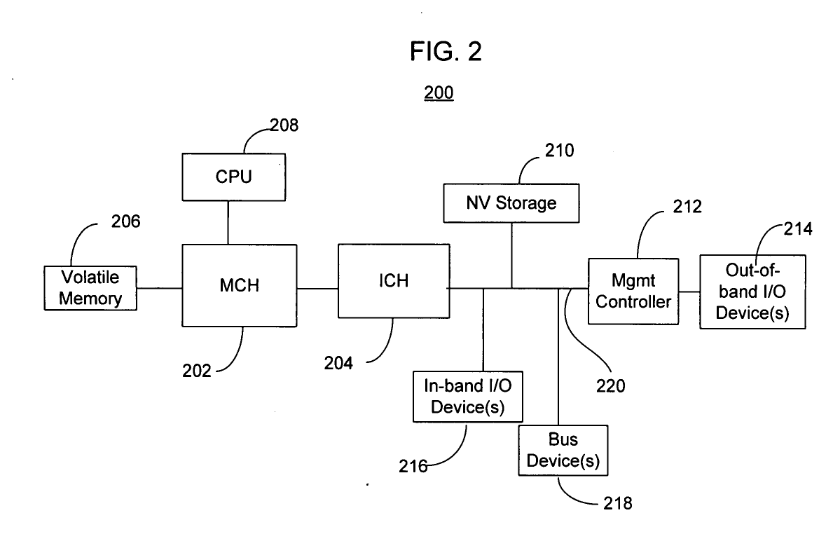

Referring now to FIG. 2 depicting a system in accordance with various embodiments. For the embodiments, the system 200 may be a partitioned platform that may include a memory controller hub (MCH) 202, an I/O controller hub (ICH) 204, volatile memory 206, a central processing unit (CPU) 208, a non-volatile (NV) memory 210 such as flash memory, a management controller 212, out-of-band I/O device(s) 214, in-band I/O device(s) 216, and bus device(s) 218, coupled together as shown. In some embodiments, the volatile memory 206 may be a random access memory (RAM) while the CPU may be a main processor employed to perform various operations related to, for example, the O/S and user applications. Bus device(s) 218 may include a mass storage such as a hard drive and/or other I/O devices such as a mouse or a keyboard. Management controller 212 may communicate with NV storage 210, ICH 204, in-band I/O device(s) 216, bus device(s) 218 via bus(as) 220.

As previously alluded to, the system 200 may be a partitioned platform that is made up of a main and a service partition. Each of the system components may be associated with the main partition, the service partition, or both. At least the management controller 212 and the out-of-band I/O device(s) 214 may be associated or dedicated to the service partition while at least the CPU 208 and the in-band I/O device(s) 216 may be associated or dedicated to the main partition. For the embodiments, the management controller 212 may facilitate the reception and/or transmission of data packets to and/or from the main partition using both the in-band I/O device(s) 216 and the out-of-band I/O device(s) 214 in the manner as previously described.

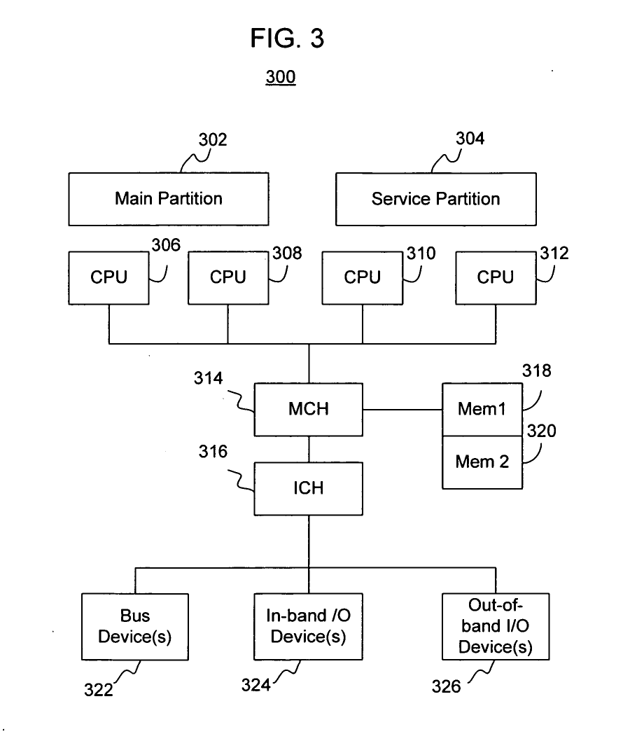

Referring now to FIG. 3 depicting another system in accordance with alternative embodiments. For the embodiments, the system 300 may also be a partitioned platform that includes a main partition 302 and a sequestered or service partition 304. The system 300 includes four CPUs 306-312, an MCH 314, an ICH 316, a first and a second memory 318-320 (which may be flash memories), bus device(s) 322, in-band I/O device(s) 324, and out-of-band I/O device(s) 326, coupled together as shown. Note that although four CPUs 306-312 are depicted, in alternative embodiments, fewer or more CPUs may be employed. Further, additional components may be included with the system 300 in other alternative embodiments. In various embodiments, at least one of the CPUs, CPU 312, may be a CPU (i.e., management controller) dedicated to the service partition 304. In contrast, the other CPUs, CPUs 306-310 may be dedicated to the main partition 302. For these embodiments, the second memory 320 and the out-of-band device(s) 326 may also be dedicated to the service partition 304 while the first memory 318 and the bus device(s) 322 may be dedicated to the main partition 302. The MCH 314, ICH 316, and the in-band I/O device(s) 324 may be shared by both the main partition 302 and the service partition 304.

The CPUs 306-310 that are dedicated to the main partition 302 may be employed to perform various operations relating to, for example, the O/S and user applications. On the other hand, the CPU 312 dedicated to the service partition 302 may be employed to perform various platform management operations typically performed by the service partition 304. In various embodiments, the CPU 312 may facilitate the reception and/or transmission to and/or from the main partition 302 using the in-band I/O device(s) 324 and the out-of-band I/O device(s) 326 in a manner as previously described.

FIGS. 2 and 3 depict just two exemplary system configurations that are contemplated in accordance with the present invention as embodied by the claims. However, other system configurations are also contemplated that do not depart from the scope and spirit of the present invention as embodied by the claims.

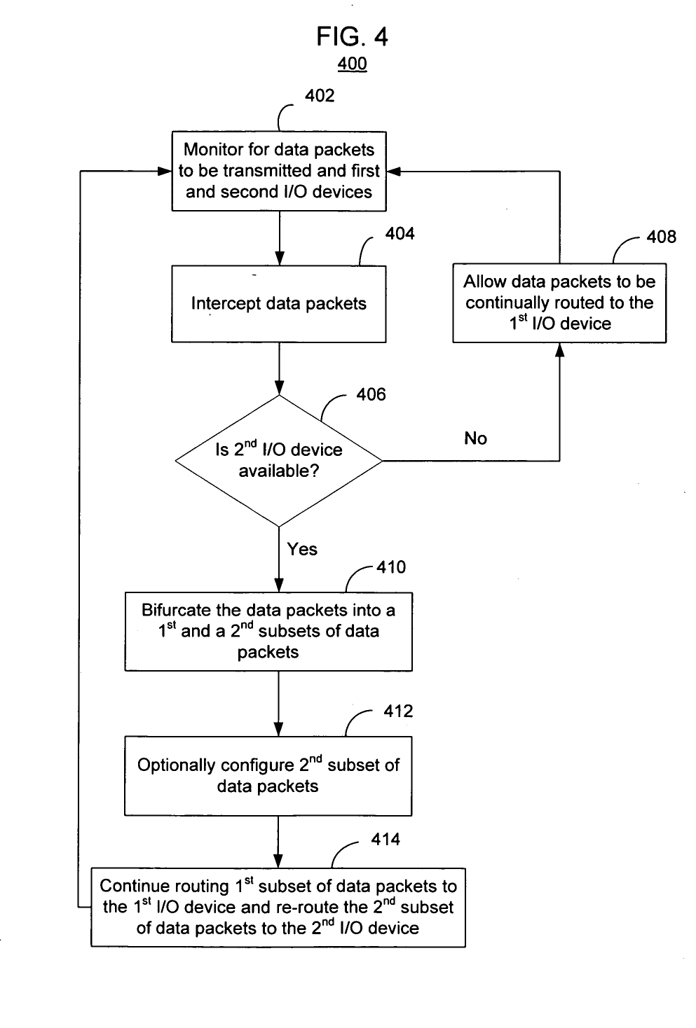

FIG. 4 depicts a process for transmitting data packets in a platform using a first and a second I/O device in accordance with various embodiments. For the embodiments, the platform may be a partitioned platform with a main and a service partition, wherein the first input device is an in-band I/O device and the second I/O device is a out-of-band I/O device. The process 400 may begin at 402 by monitoring for data packets that are designated for transmission through the first I/O device. The data packets that are being monitored for, in some embodiments, may originate from the main partition. Additionally, the activities of the first and the second I/O devices may be monitored.

Upon detection of data packets, the data packets may be intercepted by trapping the data packets using, for example, a buffer at 404. A determination may be made as to whether the second I/O device is available for transmission of data packets at 406. If the second I/O device is not available then the data packets trapped in the buffer may be allowed to be continually routed to the first I/O device at 408. On the other hand, if it is determined that the second I/O device is available for transmission of data packets then the data packets trapped in the buffer may be bifurcated into a first and a second subsets of data packets at 410. The second subset of data packets may be optionally configured to indicate that the second subset of data packets is sourced from the second I/O device at 412. The first subset of data packets may be routed to the first I/O device while the second subset of data packets may be re-routed to the second I/O device at 414. The process 400 may then be repeated over and over again.

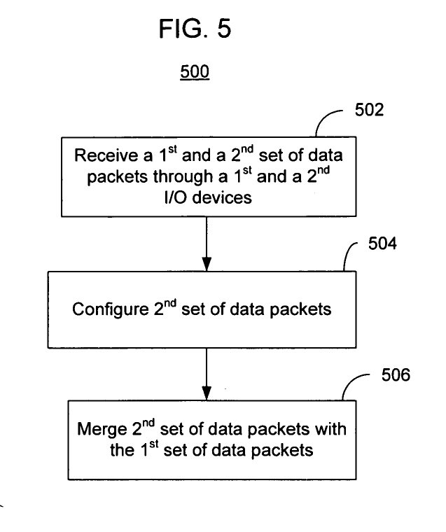

FIG. 5 depicts a process for receiving data packets in a platform using a first and a second I/O device in accordance with various embodiments. For the embodiments, the platform may be a partitioned platform with a main and a service partition, wherein the first input device is an in-band I/O device and the second I/O device is an out-of-band I/O device. The process 500 may begin when a first and a second set of data packets are received through the first and the second I/O devices, respectively, at 502. The second set of data packets to be received through the second I/O device may then be configured to indicate that the second set of data packets was received through the first I/O device at 504. As previously alluded to, this may “fool” the platform destination (e.g., main partition) into thinking that the second set of data packets was received through the first I/O device. Next, the second set of data packets may be merged with the first set of data packets at 506. The resulting merged data packets may then be received by the platform destination.

Although certain embodiments have been illustrated and described herein for purposes of description of the preferred embodiment, it will be appreciated by those of ordinary skill in the art that a wide variety of alternate and/or equivalent embodiments or implementations calculated to achieve the same purposes may be substituted for the embodiments shown and described without departing from the scope of the present invention. Those with skill in the art will readily appreciate that embodiments in accordance with the present invention may be implemented in a very wide variety of ways. This application is intended to cover any adaptations or variations of the embodiments discussed herein. Therefore, it is manifestly intended that embodiments in accordance with the present invention be limited only by the claims and the equivalents thereof.

What is claimed is:

1. A method, comprising:
intercepting a plurality of data packets on a computing device that are designated for transmission through a first input/output (I/O) device of the computing device; and
re-routing at least a subset of the data packets for transmission through a second input/output (I/O) device of the computing device.

2. The method of claim 1, wherein said second I/O device is associated with a service partition of the computing device.

3. The method of claim 2, further comprising allowing continuing routing of the intercepted data packets that are not re-routed for transmission through the second I/O device, to the first I/O device, the first I/O device being associated with a main partition of the computing device.

4. The method of claim 1, further comprising configuring the data packets re-routed for transmission through the second input/output device to indicate that the re-re-routed data packets are sourced from the second input/output device.

5. The method of claim 4, wherein said configuring comprises adding a medium access control (MAC) address of the second input/output device to the re-rerouted data packets.

6. The method of claim 1, wherein said re-routing to be performed independent of an operating system of the computing device.

7. The method of claim 1, further comprising monitoring said first and said second I/O devices and said re-routing of at least a subset of the intercepted data packets is performed based at least in part on the availability of the first and second I/O devices for transmission of data packets.

8. The method of claim 1, wherein said intercepting comprises trapping said plurality of data packets in a buffer, and the method further comprises bifurcating the buffered data packets into a first and a second subset of data packets to be routed to the first and the second I/O devices, respectively.

9. An article of manufacture, comprising:
a storage medium; and
a plurality of instructions stored in the storage medium, adapted to enable a controller of a system to perform a plurality of operations, the system having in addition to the controller, a first and a second input/output (I/O) device, the system adapted to receive a first set of data packets through the first I/O device, and the operations include:
receiving a second set of data packets through the second I/O device, the second I/O device being associated with a service partition of the system; and
interleavingly merging the second set of data packets with the first set of data packets received through the first I/O device.

10. The article of claim 9, wherein the first I/O device is associated with a main partition of the system.

11. The article of claim 9, wherein the operations further comprise configuring the second set of data packets to indicate that the second set of data packets are received through the first I/O device.

12. The article of claim 11, wherein said configuring comprises adding a medium access control (MAC) address of the first I/O device to the second set of data packets.

13. The article of claim 9, wherein said merging comprises interleavingly filling a buffer with the first and second sets of data packets and generating one or more alerts as the buffer is filled.

14. An apparatus, comprising:
a first input/output (I/O) device;
a second input/output (I/O) device associated with a service partition of the apparatus; and
a controller coupled to the first and the second I/O devices to facilitate transmission and/or reception of data packets through the first and the second I/O devices, said transmission is by intercepting a plurality of data packets that are designated for transmission through the first I/O device and re-routing at least a subset of the data packets for transmission through the second I/O device, and said reception is by receiving a first and a second set of data packets through the first and the second I/O devices, respectively, and interleavingly merging the second set of data packets with the first set of data packets.

15. The apparatus of claim 14, wherein said controller is adapted to facilitate said transmission of data packets by allowing continuing routing of intercepted data packets that are not re-routed for transmission through the second I/O device, to the first I/O device, the first I/O device being associated with a main partition of the apparatus.

16. The apparatus of claim 14, wherein said controller is adapted to facilitate said transmission of data packets by configuring data packets to be re-routed for transmission through the second I/O device to indicate that the re-routed data packets are sourced from the second I/O device.

17. The apparatus of claim 16, wherein said controller is adapted to facilitate said transmission of data packets by configuring the data packets to be re-routed for transmission through the second I/O device by adding a medium access control (MAC) address of the second I/O device to the re-routed data packets.

18. The apparatus of claim 14, wherein said controller is adapted to facilitate said transmission of data packets by monitoring said first and said second I/O devices and said re-routing of at least a subset of the intercepted data packets is performed based at least in part on the availability of the first and second I/O devices for transmission of data packets.

19. The apparatus of claim 14, further comprising a buffer and said controller is adapted to facilitate said transmission of data packets by trapping said plurality of data packets in the buffer, and bifurcate the buffered data packets into a first and a second subset of data packets to be routed to the first and the second I/O devices, respectively.

20. The apparatus of claim 14, wherein said controller is adapted to facilitate said reception of data packets by configuring the second set of data packets received through the second I/O device to indicate that the second set of data packets are received through the first I/O device.

21. The apparatus of claim 20, wherein said controller is adapted to facilitate said reception of data packets by adding a medium access control (MAC) address of the first I/O device to the second set of data packets.

22. The apparatus of claim 14, further comprising a buffer and said controller is adapted to facilitate reception of data packets by interleavingly filling the buffer with the first and second sets of data packets and generating one or more alerts as the buffer is filled.

23. A system, comprising:
a mass storage device having an operating system stored therein;
a processor;
a first input/output (I/O) device coupled to the processor and the storage device;
a second input/output (I/O) device associated with a service partition of the system; and
a controller coupled to the first and the second I/O devices to facilitate transmission and/or reception of data packets through the first and the second I/O devices, said transmission is by intercepting a plurality of data packets that are designated for transmission through the first I/O device and re-routing at least a subset of the data packets for transmission through the second I/O device, and said reception is by receiving a first and a second set of data packets through the first and the second I/O devices, respectively, and interleavingly merging the second set of data packets with the first set of data packets.

24. The system of claim 23, wherein said second I/O device is not recognized by the operating system.

25. The system of claim 24, wherein said first I/O device is recognized by the operating system.

26. The system of claim 23, wherein the first and the second I/O devices are a first and a second network interface card.
